(19) United States
(12) Patent Application Publication
(10) Pub. No.: US 2026/0144705 A1
(43) Pub. Date: May 28, 2026

(54) ENHANCED SELF-MASSAGE TOOL

(71) Applicant: Troy Stevenson, San Antonio, TX (US)

(72) Inventor: Troy Stevenson, San Antonio, TX (US)

(21) Appl. No.: 19/400,804

(22) Filed: Nov. 25, 2025

Related U.S. Application Data
(60) Provisional application No. 63/725,428, filed on Nov. 26, 2024.

(51) Int. Cl. A61H 39/04

(52) U.S. Cl. CPC A61H 39/04; A61H 2201/0119

(57) ABSTRACT

Self-massage tool designs and techniques are provided herein. A self-massage apparatus may include a base portion; and a fin-shaped portion extending upward from the base portion, the fin-shaped portion including a top surface that is flat.

### CROSS-REFERENCE TO RELATED APPLICATION(S)

This application claims the benefit of U.S. Provisional Application No. 63/725,428, filed Nov. 26, 2024, the disclosure of which is incorporated herein by reference as if set forth in full.

### TECHNICAL FIELD

This disclosure relates to self-massage tools.

### BACKGROUND

People may benefit from massages and may not always have a masseuse available to perform the massages. Improvements to self-massage designs would be beneficial.

### BRIEF DESCRIPTION OF THE DRAWINGS

FIG. 1 shows a side perspective view of an example self-massage tool, in accordance with one or more embodiments of the present disclosure.

FIG. 2 shows a side view of the self-massage tool of FIG. 1, in accordance with one or more embodiments of the present disclosure.

FIG. 3 shows a front view of the self-massage tool of FIG. 1, in accordance with one or more embodiments of the present disclosure.

FIG. 4 shows an example top view of the self-massage tool of FIG. 1, in accordance with one or more embodiments of the present disclosure.

FIG. 5 shows an example side perspective view of a self-massage tool, in accordance with one or more embodiments of the present disclosure.

FIG. 6 shows an example side perspective view of a self-massage tool, in accordance with one or more embodiments of the present disclosure.

FIG. 7 shows an example perspective view of the massage fin tool of FIG. 1 attaching to exercise equipment, in accordance with one or more embodiments of the present disclosure.

FIG. 8 shows an example side view of the massage fin tool of FIG. 1 attaching to the squat rack of FIG. 7, in accordance with one or more embodiments of the present disclosure.

FIG. 9 shows an example front view of the massage fin tool of FIG. 1 attaching to the squat rack of FIG. 7, in accordance with one or more embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

### Overview

Example embodiments described herein provide an enhanced self-massage tool.

Self-massage tools allow users to massage parts of their bodies without requiring another person to administer the massage.

The present disclosure provides enhanced self-massage tools and techniques that allow a user to leverage the force of gravity to the user's advantage. While other massage tools require a user to apply a force to administer a massage, the enhanced massage tools herein allows for the force of gravity on a person's mass to create a force by laying on a massage tool's surface(s).

The massage tools herein may be made of hard plastic or other hard materials to create a firm resistance to reach deeper tissue. Using a “fin” design, the massage tools herein may include sharper corners, similar to a forearm bone, to provide acute pressure. A spine of the massage fin tool may include a cross-section allowing for pressure to be applied to various muscle groups. The fin-shape may provide a more aggressive or a more gentle pressure. The shape of the tool along with its size may allow for massaging many body parts. The spine (e.g., top portion of the fin) may be formed by curved portions with small radii and a flat or substantially flat portion in between them. The curved portions with small radii may allow a user to target smaller muscles and/or massage a more acute body area.

The massage fin tool also may include various supporting blocks for different applications, such as a yoga block, a book/reading block, and others, to allow users to position themselves differently while applying a massage pressure to various body parts.

The massage fin design herein provides an improved self-massage compared to existing self-massage tools. The massage tool is designed to deliver varying pressure levels from large area softer pressure to small area acute pressure. The hard plastic construction of the tool provides stiff resistance to achieve deep tissue massage. The massage tool is also designed to work with gravity to provide deep effective pressure without tiring the user, and the tool's size allows for it to be used on most areas of the body.

The above descriptions are for purposes of illustration and are not meant to be limiting. Numerous other examples, configurations, processes, etc., may exist, some of which are described in greater detail below. Example embodiments will now be described with reference to the accompanying figures.

### Illustrative Processes and Use Cases

FIG. 1 shows a side perspective view of an example self-massage tool 100, in accordance with one or more embodiments of the present disclosure.

As shown in FIG. 1, the self-massage tool 100 may include a fin-shaped design with an arcing fin 102 extending upward to create a fin-like arch. The top surface 104 (e.g., spine) of the fin 102 may be substantially flat or angled. A thickness 106 of the fin 102 may range between half an inch to six inches to allow for different types of massages. The fin 102 may extend upward from a base 108, whose shape may vary. The contour of the fin 102 may vary to allow for more or less acute applications of force.

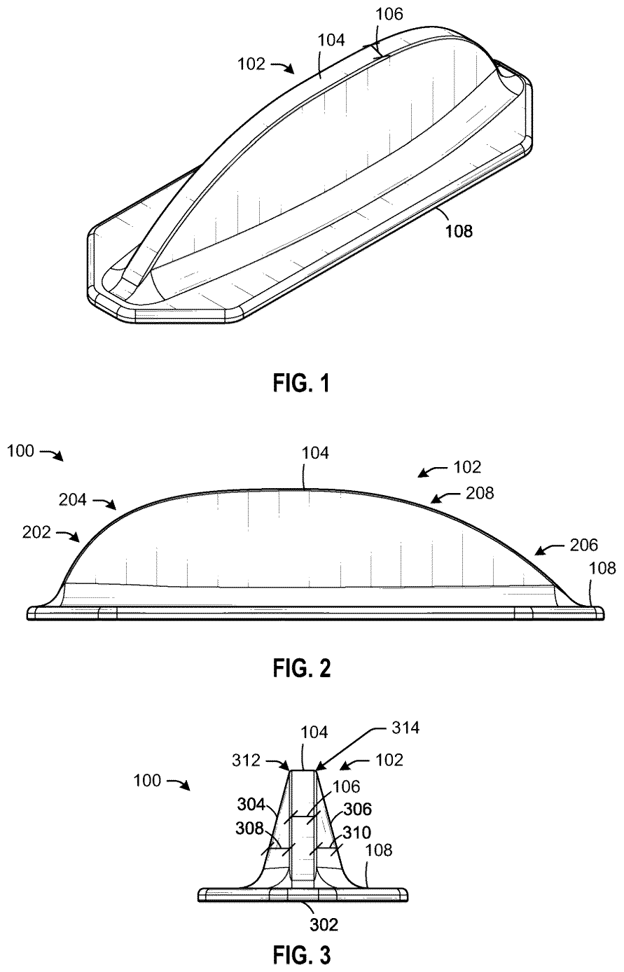

FIG. 2 shows a side view of the self-massage tool 100 of FIG. 1, in accordance with one or more embodiments of the present disclosure.

As shown in FIG. 2, the profile of the fin 102 may include multiple arcing portions (e.g., portions 202, 204, 206, 208) and a flat or substantially flat portion 104 near the top of the curve forming the fin 102. The fin's curve may be continuous to provide a smooth top surface 104 of the fin 102 onto which a person may lay.

Referring further to FIG. 2, a first portion 202 of the fin 102 may extend upward from the base 108 in a curved manner at a first radius (or changing radius), and as the fin 102 extends further from the base 108, another portion 204 may change the curvature (e.g., reducing the radius with respect to the portion 202) until leveling off at at least one point at the top 104. On the other side of the fin 102, a portion 206 extending upward from the base 108 may exhibit a first curvature (e.g., of a first radius or changing radius), and as the fin 102 extends upward from the base 108 via the portion 206, the curvature of the fin 102 may change at portion 208 (e.g., reducing the radius with respect to the portion 206). The radius/curvature of the portions 202 and 206 may be the same as each other or different from each other at at least some locations, and similarly the radius/curvature of the portions 204 and 208 may be the same as each other or different from each other at at least some locations, resulting in either a symmetric curvature/profile of the fin 102, or a non-symmetric profile of the fin 102.

FIG. 3 shows a front view of the self-massage tool 100 of FIG. 1, in accordance with one or more embodiments of the present disclosure.

Referring to FIG. 3, the fin 102 extends upward from the base 108 proximal to a front end 302 of the base 108. The top surface 104 of the fin 102 may be flat or substantially flat. The sides of the fin 102 (e.g., side 304, side 306) may not be uniform in that their curvature extending from the base 108 to the top 104 of the fin 102 may not be linear, and the thicknesses of the sides (e.g., thickness 308 of side 304, thickness 310 of side 306) may vary to provide different contouring profiles of the fin 102 to apply different pressures to the body when a person lays on the fin 102. The top surface 104 of the fin 102 may span between two curved portions: curved portion 312 connecting the side 304 to the top portion 104, and curved portion 314 connecting the side 306 to the top portion 104. The curved portions 312 and 314 may allow a user to target smaller muscles and/or a more acute body area because of their small radii.

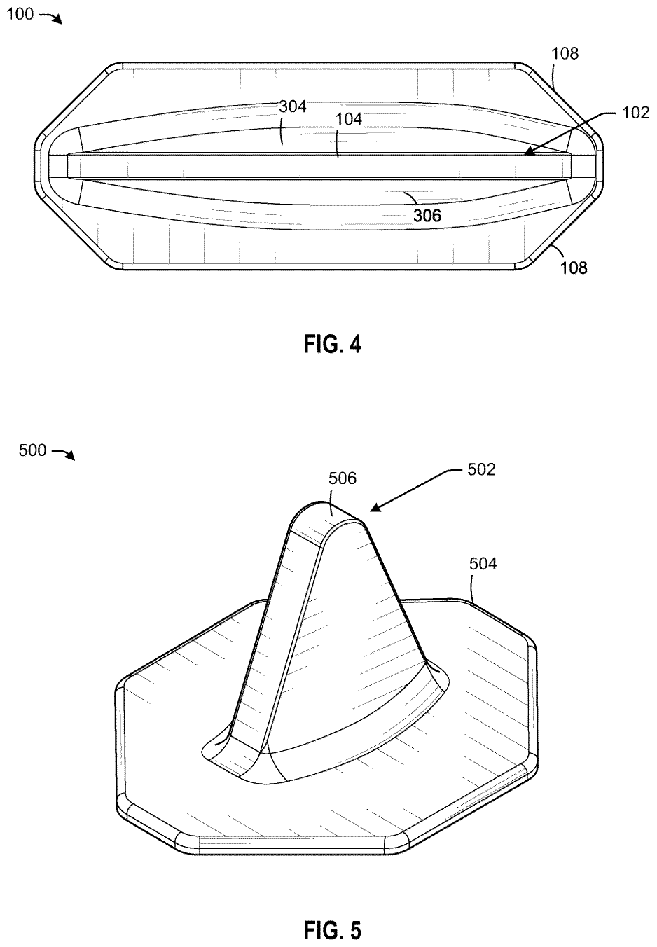

FIG. 4 shows an example top view of the self-massage tool 100 of FIG. 1, in accordance with one or more embodiments of the present disclosure.

Referring to FIG. 4, the contours of the fin 102 are shown from the top view. The sides 304 and 306 of the fin 102 may be thicker near the bottom of the fin 102 near the base 108 than the at the top 104 of the fin 102. The thicker bottom of the fin 102 may stabilize the fin 102 to allow a user to apply weight by laying on the fin 102, whereas the thinner top portion 104 of the fin 102 may apply a pressure based on the weight of the person laying on the fin 102. The fin 102 may be more curved near the front and back of the base 108 (e.g., as shown in FIG. 2), and may begin to level toward the middle of the top 104 of the fin 102 to create a flat or substantially flat surface at the peak of the fin 102.

FIG. 5 shows an example side perspective view of a self-massage tool 500, in accordance with one or more embodiments of the present disclosure.

The self-massage tool 500 shown in FIG. 5 may use a different fin 502 curvature profile than the self-massage tool 100 of FIG. 1 in that the slope of the fin 502 in FIG. 5 is steeper as it extends from a base 504 and results in a more acute angle for the fin 502. The more acute angle may produce a smaller, more pointed top surface 506 of the fin 502 to treat different parts of the body and/or to provide pressure to a smaller area of the body to which the top 506 of the fin 502 is applied.

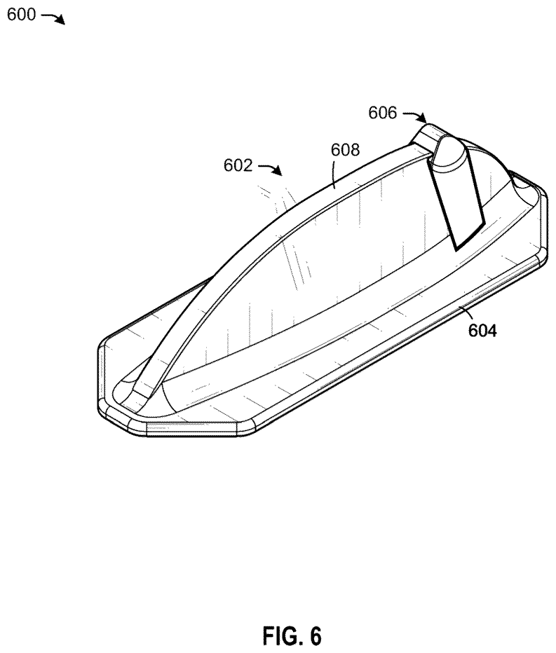

FIG. 6 shows an example side perspective view of a self-massage tool 600, in accordance with one or more embodiments of the present disclosure.

The self-massage tool 600 shown in FIG. 6 may use a different fin 602 curvature profile (e.g., extending from a base 604) than the self-massage tool 100 of FIG. 1 in that the curvature of the fin 602 in FIG. 6 may include an additional fin-like curvature 606 extending upward from the top surface 608 of the larger fin 602 to provide more precise pressure to the body, potentially in conjunction with the pressure applied with the larger fin 602 curve.

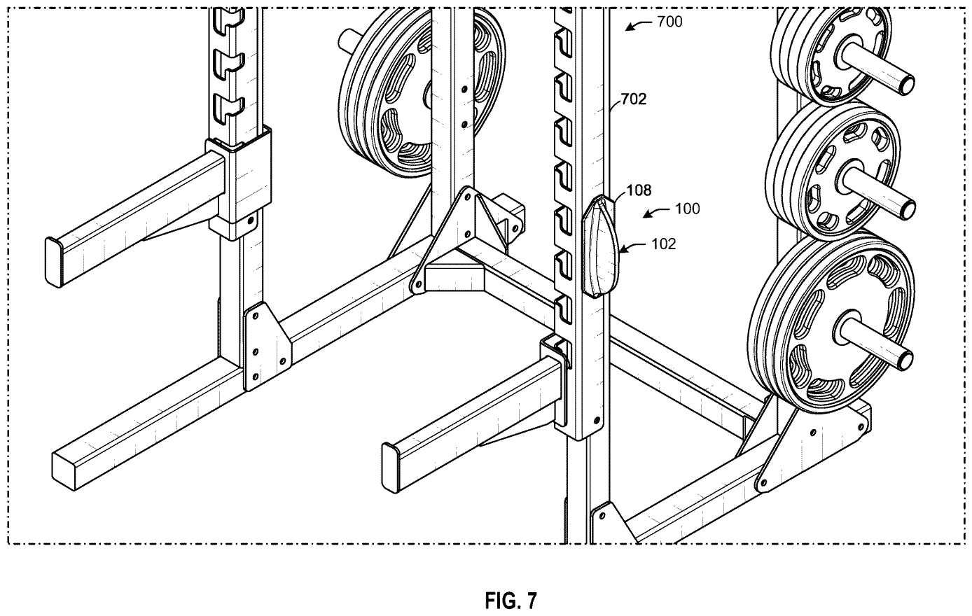

FIG. 7 shows an example perspective view of the massage fin tool 100 of FIG. 1 attaching to exercise equipment, in accordance with one or more embodiments of the present disclosure.

Referring to FIG. 7, the massage fin tool 100 is shown as attached to a portion of a squat rack 700 (e.g., specifically to a rail 702 of the squat rack 700) so that the massage fin tool 100 may be held in place at a given location/height for a user to lean into for a massage. To enable the attachment of the massage fin tool 100 to the squat rack 700 or any other exercise equipment, a bottom surface of the base 108 (e.g., a surface of the base 108 opposite the side of the base 108 from which the fin 102 extends, such as the surface of the base 108 facing the rail 702) may include a magnetic material (e.g., capable of magnetically securing the massage fin tool 100 to a metallic surface of the squat rack 700 such as the rail 702) and/or an adhesive material.

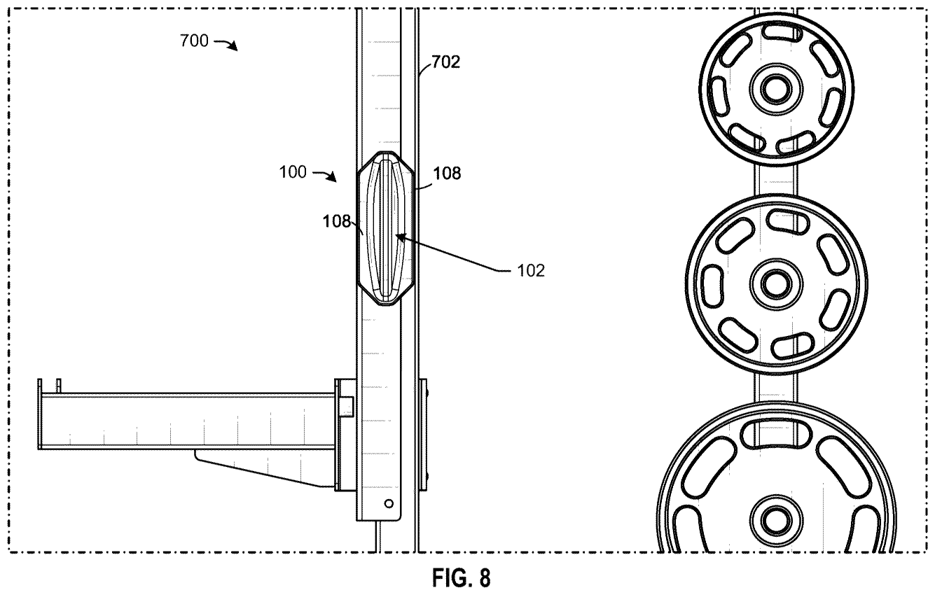

FIG. 8 shows an example side view of the massage fin tool 100 of FIG. 1 attaching to the squat rack 700 of FIG. 7, in accordance with one or more embodiments of the present disclosure.

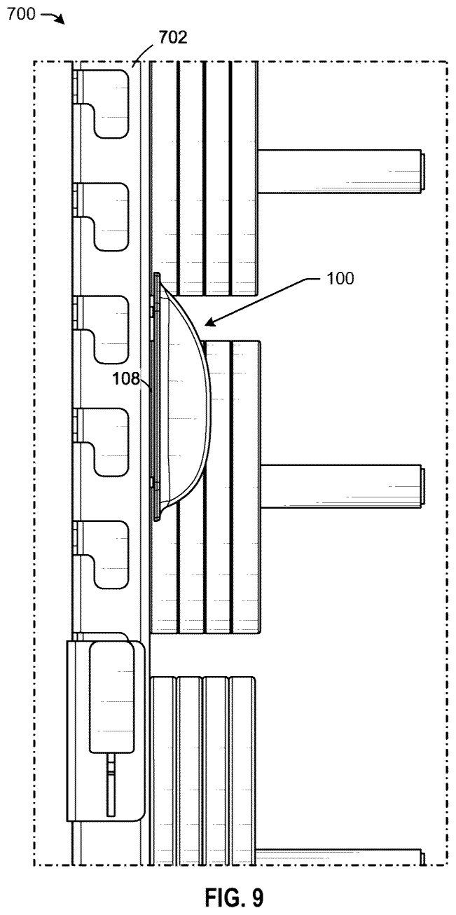

FIG. 9 shows an example front view of the massage fin tool 100 of FIG. 1 attaching to the squat rack 700 of FIG. 7, in accordance with one or more embodiments of the present disclosure.

Referring to FIGS. 7-9, the massage fin tool 100 is shown in an orientation in which the fin 102 is vertical (e.g., its contour is parallel to the rail 702), but the massage fin tool 100 may be oriented in any way that a user would prefer, such as by rotating the massage fin tool 100 with respect to the rail 702.

The embodiments described herein are not meant to be limiting.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The processes described and shown above may be carried out or performed in any suitable order as desired in various implementations. Additionally, in certain implementations, at least a portion of the processes may be carried out in parallel, creating a co-existence use case. Furthermore, in certain implementations, less than or more than the processes described may be performed.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims.

1. A self-massage apparatus comprising:
a base portion; and
a fin-shaped portion extending upward from the base portion,
wherein the fin-shaped portion comprises at least one curvature profile between the base portion and a top of the fin-shaped portion.

2. The self-massage apparatus of claim 1, wherein a surface of the top of the fin-shaped portion is flat.

3. The self-massage apparatus of claim 1, wherein the fin-shaped portion comprises two side portions extending upward from the base portion to the top, wherein a first curved portion connects a first of the two side portions to the top, and wherein a second curved portion connects a second of the two side portions to the top.

4. The self-massage apparatus of claim 3, wherein the two side portions comprise a same curvature profile as each other.

5. The self-massage apparatus of claim 3, wherein the two side portions comprise different curvature profiles from each other.

6. The self-massage apparatus of claim 3, wherein thicknesses of the two side portions vary between the base portion and the top.

7. The self-massage apparatus of claim 1, wherein the curvature profile of the fin-shaped portion is uniform and symmetric on opposite sides of the top.

8. The self-massage apparatus of claim 1, wherein the fin-shaped portion comprises non-symmetric curvature profiles on opposite sides of the top.

9. The self-massage apparatus of claim 1, wherein the fin-shaped portion comprises:
a first portion extending from the base portion and comprising a first curvature profile with a first radius;
a second portion extending from the first portion toward the top and comprising a second curvature profile with a second radius different than the first radius;
a third portion extending from the base portion and comprising the first curvature profile with the first radius; and
a fourth portion extending from the third portion toward the top and comprising the second curvature profile with the second radius.

10. The self-massage apparatus of claim 9, wherein the first radius is greater than the second radius.

11. The self-massage apparatus of claim 1, wherein the fin-shaped portion comprises:
a first portion extending from the base portion and comprising a first curvature profile with a first radius;
a second portion extending from the first portion toward the top and comprising a second curvature profile with a second radius different than the first radius;
a third portion extending from the base portion and comprising a third curvature profile with a third radius; and
a fourth portion extending from the third portion toward the top and comprising a fourth curvature profile with a fourth radius.

12. The self-massage apparatus of claim 11, wherein the first radius is different than the third radius, and wherein the second radius is different than the fourth radius.

13. The self-massage apparatus of claim 11, wherein the first radius is greater than the second radius, and wherein the third radius is greater than the fourth radius.

14. The self-massage apparatus of claim 11, further comprising a second fin-shaped portion extending from the fin-shaped portion and comprising a different curvature profile than the fin-shaped portion.

15. The self-massage apparatus of claim 11, wherein a thickness of the first portion, the second portion, the third portion, and the fourth portion is uniform between the base portion and the top.

16. The self-massage apparatus of claim 1, wherein a thickness of the fin-shaped portion along the at least one curvature profile is uniform from the base portion to the top.

17. The self-massage apparatus of claim 1, wherein the base portion comprises a magnetic material.

18. The self-massage apparatus of claim 1, wherein the fin-shaped portion is molded to the base portion.

19. The self-massage apparatus of claim 1, wherein the base portion extends further than the fin-shaped portion.

20. The self-massage apparatus of claim 1, wherein the base portion comprises at least one flat portion surrounding the fin-shaped portion.
